(19) United States
(12) Patent Application Publication
(10) Pub. No.: US 2026/0175325 A1
(43) Pub. Date: Jun. 25, 2026

(54) LASER HEAD AND LASER PROCESSING DEVICE

(71) Applicant: MAKEX GLOBAL GROUP PTE. LTD., Singapore (SG)

(72) Inventor: Guangliang HOU, Singapore (SG)

(73) Assignee: MAKEX GLOBAL GROUP PTE. LTD., Singapore (SG)

(21) Appl. No.: 19/432,143

(22) Filed: Dec. 24, 2025

Related U.S. Application Data
(63) Continuation of application No. PCT/IB2024/000745, filed on Dec. 20, 2024.

(51) Int. Cl. B23K 26/08; B23K 26/70

(52) U.S. Cl. CPC B23K 26/0876; B23K 26/703

(57) ABSTRACT

A laser head and a laser processing device are provided. The laser head includes a housing, a laser assembly, and a guide rail assembly. An accommodating cavity is formed inside the housing, and one end of the housing is provided with a light outlet. The laser assembly is arranged inside the accommodating cavity, and the laser assembly is movably arranged in a light emission direction towards the light outlet. The guide rail assembly is arranged inside the accommodating cavity and is used to slide with the laser assembly. The guide rail assembly includes a guiding portion and a rolling portion. The guiding portion is positioned on one side of the laser assembly, and the guiding portion is provided with a slideway on the side facing the laser assembly. The slideway extends in the light emission direction of the laser assembly.

### CROSS-REFERENCE OF RELATED APPLICATIONS

The present application claims the benefit of priority to International Patent Application No. PCT/IB2024/000745, filed on December 20, 2024, which is hereby incorporated by reference in its entirety.

### TECHNICAL FIELD

The present disclosure relates to the technical field of laser processing, and particularly to a laser head and a laser processing device.

### BACKGROUND

In related art, a laser assembly inside a laser head of a laser processing device is typically matched with a guiding assembly, which allows the laser assembly to move along the guiding assembly for focusing adjustments. However, the matching structure of the existing guiding assembly and the laser assembly is relatively complex, requiring additional space inside the laser head, which consequently leads to an increased occupied volume of the laser head.

### SUMMARY

The main purpose of the present disclosure is to provide a laser head and a laser processing device, aiming to reduce the occupied volume of the laser head.

To achieve the above purpose, the present disclosure provides a laser head. The laser

head includes:

a housing, where an accommodating cavity is formed inside the housing, and one end of the housing is provided with a light outlet in communication with the accommodating cavity;

a laser assembly, where the laser assembly is arranged inside the accommodating cavity, and the laser assembly is movably arranged in a light emission direction towards the light outlet; and

a guide rail assembly, where the guide rail assembly is arranged inside the accommodating cavity and is used to slide with the laser assembly.

The guide rail assembly includes:

a guiding portion, where the guiding portion is positioned on one side of the laser assembly, and the guiding portion is provided with a slideway on the side facing the laser assembly, the slideway extends in the light emission direction of the laser assembly; and

a rolling portion, where the rolling portion is arranged inside the slideway, at least a part of the rolling portion is configured to roll, and at least a part of the laser assembly is constrained within the slideway and engages with the rolling portion in a rolling manner, so that the laser assembly can slide relative to the guiding portion.

In one implementation, the rolling portion includes a rolling element, and an outer peripheral surface of the rolling element abuts the laser assembly to engage with the laser assembly in a rolling manner; and

a plurality of rolling elements are provided, and the plurality of rolling elements are arranged within the slideway and sequentially along the length direction of the slideway.

In one implementation, the rolling portion further includes a mounting element, the mounting element is positioned within the slideway and on one side of the laser assembly, and extends along the length direction of the slideway; and

the plurality of rolling elements are sequentially arranged along the length direction of the mounting element, and are respectively rotatably mounted on the mounting element, with at least a part of the rolling elements protruding from a side surface of the mounting element facing the laser assembly to abut the laser assembly.

In one implementation, the rolling element has a central axis and is rotatable around the central axis, and the central axis is perpendicular to the light emission direction of the laser assembly; and/or

a first groove is provided on a side of the laser assembly facing the mounting element, the first groove is positioned opposite the mounting element and extends along the length direction of the mounting element, and at least a part of the rolling element is limited within the first groove; and/or

an inner wall of the slideway is provided with a second groove, the second groove is positioned opposite the mounting element and extends along the length direction of the mounting element, and at least a part of the rolling element protrudes from a side surface of the mounting element facing the second groove and is limited within the second groove.

In one implementation, the guiding portion includes two side edge structures, and the two side edge structures are arranged at an interval to enclose and form the slideway, with at least a part of the laser assembly being limited between the two side edge structures; and

two rolling portions are provided, and each side edge structure is provided with one rolling portion on a side facing the other side edge structure.

In one implementation, the guiding portion further includes a mounting structure, the mounting structure is positioned on a side chamber wall of the accommodating cavity, and the two side edge structures are arranged at an interval on a side of the mounting structure away from the chamber wall to enclose and form the slideway with the mounting structure.

In one implementation, the laser head further includes a mainboard assembly, the mainboard assembly is positioned within the accommodating cavity and is arranged at an interval on a side of the laser assembly away from the guide rail assembly, and extends along the light emission direction of the laser assembly.

In one implementation, a plug structure is provided on a side of the mainboard assembly away from the laser assembly; and

an outer side wall of the housing is provided with a socket in communication with the accommodating cavity, the socket is positioned opposite the plug structure, and the plug structure passes through the socket.

In one implementation, the laser head further includes a drive assembly, the drive assembly is positioned within the accommodating cavity and located between the mainboard assembly and the guide rail assembly, and is adjacent to the laser assembly; and

the drive assembly is in transmission connection with the laser assembly to drive the laser assembly to reciprocate relative to the guide rail assembly.

In one implementation, an end of the housing away from the light outlet is provided with a wind-passing opening in communication with the accommodating cavity, and at least a part of the laser assembly is spaced from a chamber wall of the accommodating cavity to enclose and form a heat dissipation air duct in communication with the wind-passing opening and the light outlet; and

the laser head further includes a fan assembly, and the fan assembly is positioned within the heat dissipation air duct.

In one implementation, the laser head further includes a heat dissipation assembly, the heat dissipation assembly is positioned within the heat dissipation air duct and located around the laser assembly, and is connected to the laser assembly; and

the wind-passing opening is positioned on a side wall of the housing, and the fan assembly is positioned on a side of the laser assembly away from the light outlet and adjacent to the wind-passing opening, to guide airflow to enter the heat dissipation air duct from a side of the laser head, so that after flowing through the laser assembly and the heat dissipation assembly, the airflow blows towards the front of the light outlet.

In one implementation, two heat dissipation assemblies are provided, and the two heat dissipation assemblies are positioned on opposite sides of the laser assembly; and/or

an outer surface of the laser assembly is provided with a slot, and the heat dissipation assembly is inserted into the slot; and/or

the heat dissipation assembly includes a plurality of heat dissipation elements, the heat dissipation elements are tubular, and the plurality of heat dissipation elements are sequentially arranged along the light emission direction of the laser assembly.

The present disclosure also proposes a laser processing device, the laser processing device includes:

the above-mentioned laser head;

a casing, the casing is provided with a pick-and-place opening in communication with an inside of the casing;

a cover plate, the cover plate is configured for opening and closing the pick-and-place opening; and

a track device, the track device is positioned within the casing, and the laser head is movably positioned on the track device.

In one implementation, the casing includes:

a chassis, the chassis is an integrated structure and has an accommodating space, and the track device is positioned on the chassis;

a carrying assembly, the carrying assembly is positioned on the chassis and located at the accommodating space, and the laser head is used to process a workpiece positioned on the carrying assembly; and

a shell, the shell is positioned on the chassis and covers the track device and the laser head, and the shell is provided with the pick-and-place opening.

In one implementation, the track device includes:

a first track assembly, the first track assembly is mounted on the chassis and is positioned along a first direction on opposite sides of the accommodating space;

a second track assembly, the second track assembly is movably positioned along a second direction on the first track assembly; and

a front support frame, the front support frame extends along the first direction and is connected to the two first track assemblies, and a lighting lamp for providing illumination is provided at an end of the front support frame along the first direction.

In one implementation, a mounting portion protrudes from a side of the chassis facing the laser head, and the laser processing device further includes a flame sensor for sensing a flame. The flame sensor is positioned on the mounting portion and above the carrying assembly.

In the technical solution of the present disclosure, a laser assembly and a guide rail assembly are provided inside the housing of the laser head, where the guide rail assembly includes a guiding portion and a rolling portion. The guiding portion is provided with a slideway on the side facing the laser assembly, and the slideway extends in the light emission direction of the laser. The rolling portion is arranged inside the slideway, and at least a part of the rolling portion is capable of rolling. By limiting at least a part of the laser assembly within the slideway and engaging with the rolling element in a rolling manner, the laser assembly can slide relative to the guiding portion under the rolling action of the rolling portion, so that the guide rail assembly can guide the laser assembly, facilitating the moving focusing of the laser assembly. By allowing a part of the structure of the laser assembly to extend into the guiding portion of the guide rail assembly, the assembly compactness between the laser assembly and the guide rail assembly can be improved, thereby reducing the occupied space inside the laser head and further reducing the occupied volume of the laser head.

### BRIEF DESCRIPTION OF DRAWINGS

In order to more clearly illustrate the technical solutions in the implementations of the present disclosure or the related art, the drawings used for the description of the implementations or the related art are briefly introduced below. It is obvious that the drawings described below are only some implementations of the present disclosure. Those of ordinary skill in the art can also obtain other drawings based on these drawings without creative work.

FIG. 1 is a structural schematic diagram of a laser processing device according to some implementations of the present disclosure.

FIG. 2 is a partial structural diagram of the laser processing device in FIG. 1.

FIG. 3 is an exploded view of a partial structure of the laser processing device in FIG. 1.

FIG. 4 is a structural schematic diagram of a laser head according to some implementations of the present disclosure.

FIG. 5 is a sectional view of the laser head in FIG. 4.

FIG. 6 is a schematic diagram of a partial structure of the laser head in FIG. 4.

FIG. 7 is an exploded view of a partial structure of the laser head in FIG. 6.

FIG. 8 is a structural schematic diagram of the laser assembly in FIG. 4.

FIG. 9 is a structural schematic diagram of the guide rail assembly in FIG. 4.

FIG. 10 is a sectional view of the laser head in FIG. 4 from another perspective.

The realization of the purpose, functional features, and advantages of the present disclosure will be further described in conjunction with the implementations and with reference to the drawings.

### DETAILED DESCRIPTION

The following will provide a description of the technical solutions in the implementations of the present disclosure with reference to the drawings. Obviously, the described implementations are only a part of the implementations of the present disclosure, and not all of the implementations. Based on the implementations of the present disclosure, all other implementations obtained by those of ordinary skill in the art without creative work shall fall within the scope of protection of the present disclosure.

It should be noted that if there are directional indications involved in the implementations of the present disclosure, such directional indications are only used to explain the relative positional relationships, movements, etc., between the components under a certain specific posture. If the specific posture changes, the directional indications may also change accordingly.

In addition, if there are descriptions such as “first,” “second,” etc., in the implementations of the present disclosure, such descriptions are only for the purpose of description, and should not be understood as indicating or implying their relative importance or implicitly indicating the number of the indicated technical features. Therefore, features defined with “first” and “second” may explicitly or implicitly include at least one such feature. In addition, if “and/or” appears in the present disclosure, its meaning includes three parallel scenarios. Taking “A and/or B” as an example, it includes the scenario of A, or the scenario of B, or the scenario where both A and B are satisfied at the same time. In addition, the technical solutions of various implementations can be combined with each other, but must be based on the premise that those of ordinary skill in the art can realize them. When the combination of technical solutions is contradictory or cannot be realized, it should be considered that such a combination does not exist and is not within the scope of protection required by the present disclosure.

In related art, a laser assembly inside a laser head of a laser processing device is typically matched with a guiding assembly, which allows the laser assembly to move along the guiding assembly for focusing adjustments. However, the matching structure of the existing guiding assembly and the laser assembly is relatively complex, requiring additional space inside the laser head, which consequently leads to an increased occupied volume of the laser head.

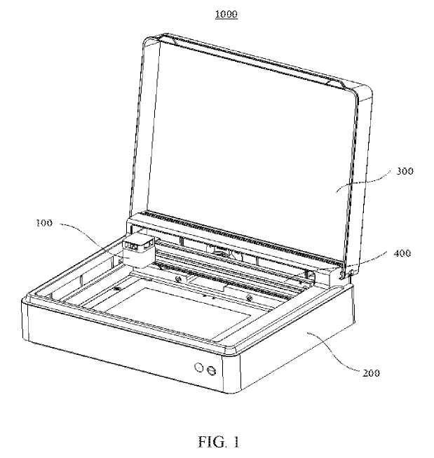

Therefore, based on the above considerations, to address the issue of excessive occupied volume in the laser head of the current laser processing device, the present disclosure provides a novel laser head 100. Please refer to FIGS. 1 to 10. In some implementations of the present disclosure, the laser head 100 includes a housing 10, a laser assembly 20, and a guide rail assembly 30. An accommodating cavity 10a is formed inside the housing 10, and one end of the housing 10 is provided with a light outlet 11 in communication with the accommodating cavity 10a. The laser assembly 20 is arranged inside the accommodating cavity 10a, and the laser assembly 20 is movably arranged in a light emission direction towards the light outlet 11 The guide rail assembly 30 is arranged inside the accommodating cavity 10a and is configured to slidably engage with the laser assembly 20.

The guide rail assembly 30 includes a guiding portion 31 and a rolling portion 32. The guiding portion 31 is positioned on one side of the laser assembly 20, and the guiding portion 31 is provided with a slideway 31a on the side facing the laser assembly 20. The slideway 31a extends in the light emission direction of the laser assembly 20. The rolling portion 32 is arranged inside the slideway 31a, where at least a part of the rolling portion 32 is capable of rolling, and at least a part of the laser assembly 20 is constrained within the slideway 31a and engages with the rolling portion 32 in a rolling manner, so that the laser assembly 20 can slide relative to the guiding portion 31.

An accommodating cavity 10a is formed inside the housing 10, and components such as the laser assembly 20 and the guide rail assembly 30 can be arranged inside the accommodating cavity 10a. The chamber wall of the accommodating cavity 10a can be used to install, fix, and support components such as the guide rail assembly 30, thereby providing an installation foundation for each component of the laser head 100. Each component of the laser head 100 can, but is not limited to, be detachably connected to the housing 10 by means such as snap-fit connection, plug-in fit, screw connection, or pin connection.

The guiding portion 31 and the laser assembly 20 both extend in the vertical direction and are arranged side by side in the accommodating cavity 10a of the housing 10. The guiding portion 31 can be directly fixed to the chamber wall of the accommodating cavity 10a and has a guiding surface facing the laser assembly 20. Two spaced side edge structures 311 can be protrudingly provided on the guiding surface to enclose and form a slideway, or a slideway can be directly recessed on the guiding surface, thereby forming the slideway 31a of the guiding portion 31. The specific implementation can be set according to actual needs and is not limited herein.

The laser assembly 20 includes a laser and a fixing member for installing and fixing the laser. The laser assembly 20 can be connected and matched with other functional components inside the laser head 100 through the fixing member. In this implementation, at least a part of the fixing member of the laser assembly 20 is constrained within the slideway 31a, so the laser assembly 20 can be guided to perform linear reciprocating motion through the slideway 31a of the guiding portion 31.

In some implementations, a rolling portion 32 is also provided inside the slideway 31a. The rolling portion 32 can enable the laser assembly 20 to slide relative to the guiding portion 31 by rolling engagement with the laser assembly 20. This arrangement is also conducive to reducing the friction force when the laser assembly 20 slides, thereby facilitating the advancement of the laser assembly 20 in its light emission direction.

It can be understood that, compared with the technical solution of arranging the entire laser outside the optical axis guide rail, by allowing a part of the structure of the laser assembly 20 to extend into the guiding portion 31 of the guide rail assembly 30, the assembly compactness between the laser assembly 20 and the guide rail assembly 30 can be improved, thereby reducing the occupied space inside the laser head 100 and further reducing the occupied volume of the laser head 100.

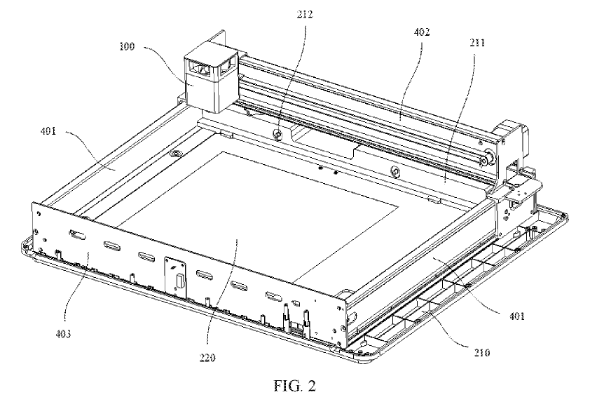

Please refer to FIGS. 2 to 4. In the implementation of the present disclosure, the rolling portion 32 includes a rolling element 321, and the outer peripheral surface of the rolling element 321 abuts the laser assembly 20 to engage with the laser assembly 20 in a rolling manner. A plurality of rolling elements 321 are provided, and the plurality of rolling elements 321 are arranged within the slideway 31a and are sequentially arranged along the length direction of the slideway 31a.

The rolling element 321 can, but is not limited to, be set as a ball, a roller, or other rolling structure. Specifically, the outer peripheral surface of the rolling element 321 includes a rolling surface arranged around a central axis, and the rolling element 321 can abut the outer wall of the laser assembly 20 through the rolling surface. When the rolling element 321 rotates around the central axis, the rolling surface can rotate relative to the outer wall of the laser assembly 20, so as to realize the rolling engagement between the outer peripheral surface of the rolling element 321 and the laser assembly 20.

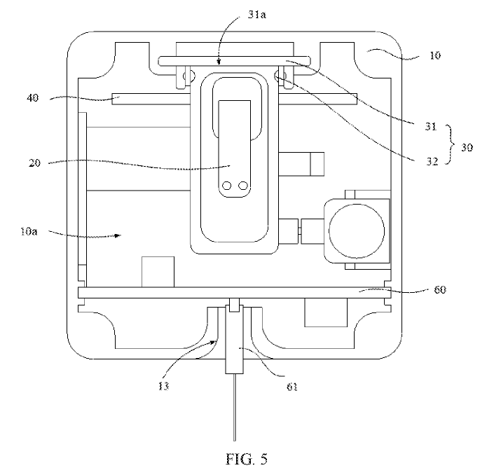

Please refer to FIGS. 5 to 7. In some implementations of the present disclosure, the rolling portion 32 further includes a mounting element 322. The mounting element 322 is positioned within the slideway 31a and on one side of the laser assembly 20, and extends along the length direction of the slideway 31a. The plurality of rolling elements 321 are sequentially arranged along the length direction of the mounting element 322 and are respectively rotatably mounted on the mounting element 322, with at least a part of the rolling elements 321 protruding from a side surface of the mounting element 322 facing the laser assembly 20 to abut the laser assembly 20.

By providing the mounting element 322 to rotatably mount a plurality of rolling elements 321, it is convenient to limit each rolling element 321, so as to improve the structural stability of the rolling portion 32 and reduce the risk of deviation of each rolling element 321. In addition, the plurality of rolling elements 321 can be integrated into an integral structure through the mounting element 322, which is conducive to improving the assembly convenience of the rolling portion 32 and the guiding portion 31.

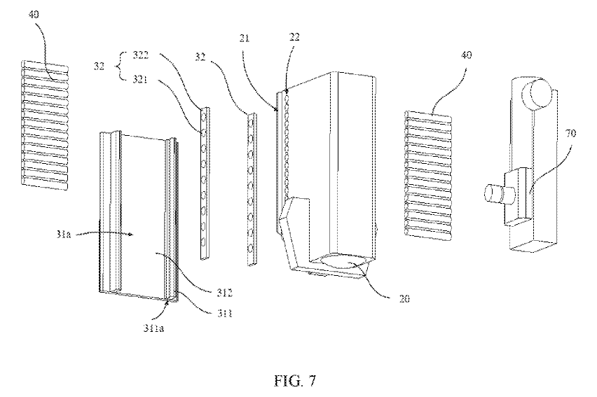

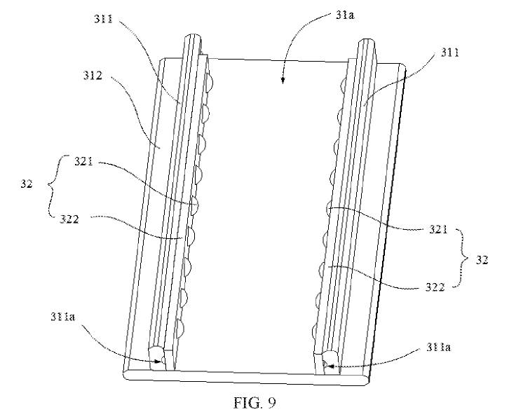

Please refer to FIGS. 7 and 9. In some implementations of the present disclosure, the rolling element 321 has a central axis and is rotatable around the central axis, and the central axis is perpendicular to the light emission direction of the laser assembly 20. In this way, when the laser assembly 20 moves in the light emission direction towards the light outlet, the rolling element 321 can rollingly engage with the laser assembly 20, thereby facilitating the advancement of the laser assembly 20 in its light emission direction.

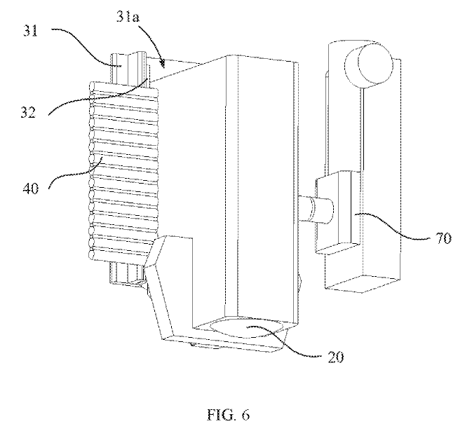

Please refer to FIGS. 6 to 8. In some implementations of the present disclosure, a first groove 21 is provided on a side of the laser assembly 20 facing the mounting element 322. The first groove 21 is positioned opposite the mounting element 322 and extends along the length direction of the mounting element 322, and at least a part of the rolling element 321 is constrained within the first groove 21. The part of the rolling element 321 extending into the first groove 21 can rollingly engage with the groove wall of the first groove 21. The cross-sectional shape of the first groove 21 is adapted to the shape of the rolling element 321 to ensure the limiting effect of the first groove 21 on the rolling element 321, thereby improving the positional stability of the rolling portion 32.

Similarly, please refer to FIGS. 6 to 9. In some implementations of the present disclosure, the inner wall of the slideway 31a is provided with a second groove 311a. The second groove 311a is positioned opposite the mounting element 322 and extends along the length direction of the mounting element 322, and at least a part of the rolling element 321 protrudes from a side surface of the mounting element 322 facing the second groove 311a and is constrained within the second groove 311a. The part of the rolling element 321 extending into the second groove 311a can rollingly engage with the groove wall of the second groove 311a. The cross-sectional shape of the second groove 311a is adapted to the shape of the rolling element 321 to ensure the limiting effect of the second groove 311a on the rolling element 321, thereby improving the positional stability of the rolling portion 32.

It should be noted that the technical solution of the present disclosure can set the first groove 21 on the outer wall of the laser assembly 20 to limit the rolling portion 32, or set the second groove 311a on the inner wall of the slideway 31a of the guiding portion 31 to limit the rolling portion 32. In some implementations, both the outer wall of the laser assembly 20 and the inner wall of the slideway 31a of the guiding portion 31 can be respectively provided with the first groove 21 and the second groove 311a, so that the first groove 21 and the second groove 311a can cooperatively limit the rolling portion 32, thereby further improving the positional stability of the rolling portion 32.

Please refer to FIG. 9. In some implementations of the present disclosure, the guiding portion 31 includes two side edge structures 311, and the two side edge structures 311 are arranged at an interval to enclose and form the slideway 31a, with at least a part of the laser assembly 20 being constrained between the two side edge structures 311. Two rolling portions 32 are provided, and each side edge structure 311 is provided with one rolling portion 32 on a side facing the other side edge structure 311.

In this implementation, the two side edge structures 311 can be spaced apart in the horizontal direction and are respectively arranged on the opposite sides of the laser assembly 20, and are closely engaged with the outer wall of the laser assembly 20 through the rolling portion 32. With this arrangement, the two side edge structures 311 can limit the laser assembly 20 in the horizontal direction, improving the positional stability of the laser assembly 20, and the slideway 31a enclosed by the two side edge structures 311 can guide the laser assembly 20 to reciprocate in the vertical movement.

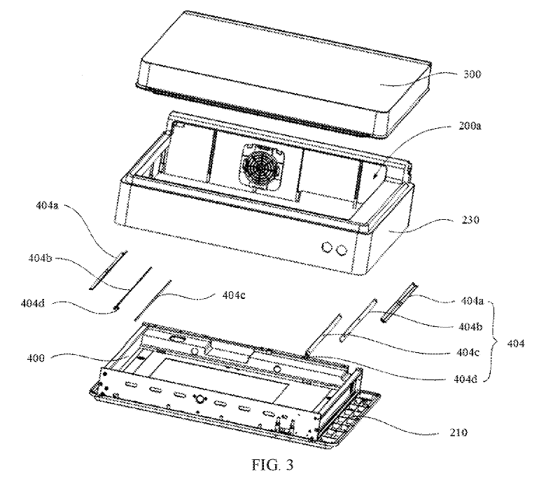

Please refer to FIGS. 3 and 6. In some implementations of the present disclosure, the guiding portion 31 further includes a mounting structure 312. The mounting structure 312 is positioned on a side chamber wall of the accommodating cavity 10a, and the two side edge structures 311 are arranged at an interval on a side of the mounting structure 312 away from the chamber wall to enclose and form the slideway 31a with the mounting structure 312.

By providing the mounting structure 312 to fixedly connect the two side edge structures 311, the various structures of the guiding portion 31 can be integrated into an integral structure, which is conducive to improving the assembly convenience of the rolling portion 32 and the guiding portion 31. In addition, the mounting structure 312 can be arranged at an interval with the laser assembly 20, and the laser assembly 20 can be constrained only by the two side edge structures 311. The mounting structure 312 can also cooperate with the two side edge structures 311 to enclose and form the slideway 31a, and the shape of the slideway 31a can be adapted to the laser assembly 20 to ensure the constraining effect on the laser assembly 20.

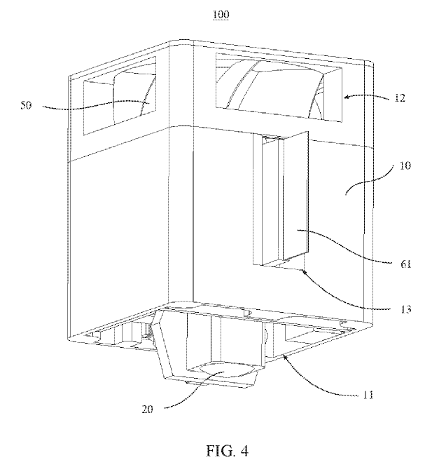

Please refer to FIGS. 4 and 5. In some implementations of the present disclosure, the laser head 100 further includes a mainboard assembly 60. The mainboard assembly 60 is positioned within the accommodating cavity 10a and is arranged at an interval on a side of the laser assembly 20 away from the guide rail assembly 30, and extends along the light emission direction of the laser assembly 20.

The mainboard assembly 60 extends along the light emission direction of the laser assembly 20 and is arranged side by side with the laser assembly 20 in the accommodating cavity 10a. The mainboard assembly 60 can be fixed to a side chamber wall of the accommodating cavity 10a. In this way, a reasonable layout of the internal structure of the laser head 100 can be realized, which is conducive to reducing the occupied volume of the laser head 100.

Please refer to FIGS. 4 and 5. In some implementations of the present disclosure, a plug structure 61 is provided on a side of the mainboard assembly 60 away from the laser assembly 20. An outer side wall of the housing 10 is provided with a socket 13 in communication with the accommodating cavity 10a, the socket 13 is positioned opposite the plug structure 61, and the plug structure 61 passes through the socket 13. With this arrangement, it is convenient for the mainboard assembly 60 to be electrically connected to an external module.

Please refer to FIGS. 4 to 6. In some implementations of the present disclosure, the laser head 100 further includes a drive assembly 70. The drive assembly 70 is positioned within the accommodating cavity 10a and located between the mainboard assembly 60 and the guide rail assembly 30, and is adjacent to the laser assembly 20. The drive assembly 70 is in transmission connection with the laser assembly 20 to drive the laser assembly 20 to reciprocate relative to the guide rail assembly 30.

The drive assembly 70 can, but is not limited to, be set as a drive motor, a servo motor, a drive motor, or other drive structure, to drive the laser assembly 20 to perform linear reciprocating motion along the length direction of the guide rail assembly 30, thereby realizing the moving focusing function of the laser.

By arranging the drive assembly 70 between the mainboard assembly 60 and the guide rail assembly 30, and making the output end of the drive assembly 70 face the laser assembly 20, the layout space around the laser assembly 20 can be fully utilized. In some implementations, the drive assembly 70 extends along the light emission direction of the laser assembly 20 and is arranged side by side with the laser assembly 20 in the accommodating cavity 10a. The drive assembly 70 can be fixed to a side chamber wall of the accommodating cavity 10a. In this way, a reasonable layout of the internal structure of the laser head 100 can be realized, which is conducive to reducing the occupied volume of the laser head 100.

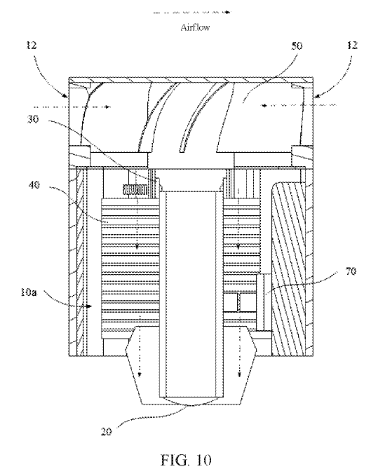

Please refer to FIGS. 4 and 10. In some implementations of the present disclosure, an end of the housing 10 away from the light outlet 11 is provided with a wind-passing opening 12 in communication with the accommodating cavity 10a, and at least a part of the laser assembly 20 is spaced from a chamber wall of the accommodating cavity 10a to enclose and form a heat dissipation air duct in communication with the wind-passing opening 12 and the light outlet 11. The laser head 100 further includes a fan assembly 50, and the fan assembly 50 is positioned within the heat dissipation air duct. The fan assembly 50 can, but is not limited to, be set as a radial fan, a centrifugal fan, an axial fan, or the like. The fan assembly 50 can drive the external space to flow from the wind-passing opening 12 to the light outlet 11, realizing the air-cooled heat dissipation function of the laser head 100.

Please refer to FIGS. 5 and 10. In some implementations of the present disclosure, the laser head 100 further includes a heat dissipation assembly 40. The heat dissipation assembly 40 is positioned within the heat dissipation air duct and located around the laser assembly 20, and is connected to the laser assembly 20. The wind-passing opening 12 is positioned on a side wall of the housing 10, and the fan assembly 50 is positioned on a side of the laser assembly 20 away from the light outlet 11 and adjacent to the wind-passing opening 12, to guide airflow to enter the heat dissipation air duct from a side of the laser head 100, so that after flowing through the laser assembly 20 and the heat dissipation assembly 40, the airflow blows towards the front of the light outlet 11.

The laser assembly 20 generates a large amount of heat during operation. In order to avoid excessive heat remaining in the laser assembly 20, resulting in component aging and shortened service life, the technical solution of the present disclosure provides a heat dissipation assembly 40 around the laser assembly 20. The heat generated by the laser assembly 20 can be transferred to the heat dissipation assembly 40, and the fan assembly 50 can drive air to quickly flow through the heat dissipation assembly 40, so as to timely remove the heat at the heat dissipation assembly 40, thereby ensuring the air-cooled heat dissipation effect of the laser assembly 20.

The fan assembly 50 can be specifically configured as a radial fan, and the axis direction of the fan assembly 50 can be parallel to the light emission direction of the laser assembly, for blowing air towards the light outlet 11. The wind-passing opening 12 can be provided on the periphery of the fan assembly 50, so that the airflow can enter the wind-passing opening 12 provided on the side wall of the housing 10 in a direction perpendicular to the axis of the fan assembly 50 under the drive of the fan assembly 50, and then flow along the axis direction of the fan assembly 50. Thus, after flowing through the laser assembly 20 and the heat dissipation assembly 40 located around the laser assembly 20, the airflow is discharged from the light outlet 11 at the end of the housing 10, forming a side-in and bottom-out airflow mode, thereby realizing the air-cooled heat dissipation function of the laser head 100.

In some implementations, a part of the outer wall of the housing 10 can be formed by the casing of the fan assembly 50, which is conducive to improving the integration of the laser head 100 and reducing the occupied volume of the laser head 100. In some implementations, the fan assembly 50 can also be entirely arranged inside the housing 10, which is not limited herein.

Please refer to FIGS. 5 to 8. In some implementations of the present disclosure, two heat dissipation assemblies 40 are provided, and the two heat dissipation assemblies 40 are positioned on opposite sides of the laser assembly 20. With this arrangement, the free space on the opposite sides of the laser assembly 20 can be fully utilized to arrange the heat dissipation assemblies 40, thereby achieving a reasonable layout of the internal structure of the laser head 100, which is conducive to reducing the occupied volume of the laser head 100.

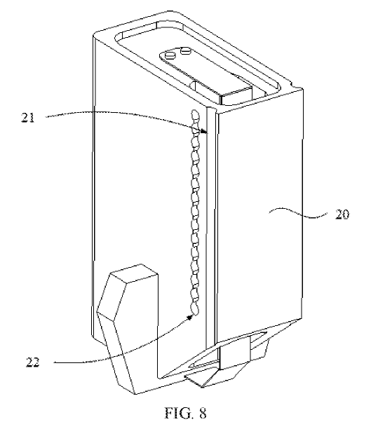

Please refer to FIGS. 6 and 8. In some implementations of the present disclosure, an outer surface of the laser assembly 20 is provided with a slot 22, and the heat dissipation assembly 40 is inserted into the slot 22. The shape of the slot 22 is adapted to the heat dissipation assembly 40, and the detachable connection between the laser assembly 20 and the heat dissipation assembly 40 can be realized by plug-in fit, so as to improve the plug-in stability of the heat dissipation assembly 40. In this way, on the one hand, the slot 22 can limit the heat dissipation assembly 40 to improve the installation stability of the heat dissipation assembly 40, and on the other hand, the simple assembly structure between the laser assembly 20 and the heat dissipation assembly 40 can improve the assembly convenience of the laser head 100.

Please refer to FIG. 6. In some implementations of the present disclosure, the heat dissipation assembly 40 includes a plurality of heat dissipation elements. The heat dissipation elements are tubular, and the plurality of heat dissipation elements are sequentially arranged along the light emission direction of the laser assembly 20.

The light emission direction of the laser assembly 20 is the vertical direction, and the plurality of heat dissipation elements are sequentially arranged in the vertical direction. In this way, the heat dissipation elements can be in full contact with the outer wall of the laser assembly 20. In addition, the heat dissipation elements are tubular structures extending in the horizontal direction, which can provide a large heat dissipation area for the heat dissipation elements, so as to realize rapid heat dissipation of the laser assembly 20 and ensure the normal operation of the laser assembly 20.

The technical solution of the present disclosure is not limited to this. In some implementations, the heat dissipation elements can also be implemented as sheet structures to form heat dissipation fins, and a plurality of heat dissipation fins are sequentially spaced apart. The heat dissipation elements can also be set as other shapes, and the specific implementation can be set according to actual needs and is not limited herein.

The present disclosure also proposes a laser processing device 1000, which includes the laser head 100. The specific structure of the laser head 100 refers to the above implementations. Since the laser processing device 1000 adopts all the technical solutions of the above implementations, it at least has all the beneficial effects brought by the technical solutions of the above implementations, which will not be repeated here.

Please refer to FIGS. 1 to 3. The laser processing device 1000 further includes a casing 200, a cover plate 300, and a track device 400. The casing 200 is provided with a pick-and-place opening 200a in communication with an inside of the casing 200; the cover plate 300 is capable of opening and closing the pick-and-place opening 200a; and the track device 400 is positioned within the casing 200. The laser head 100 is movably positioned on the track device 400.

The inside of the casing is hollow for accommodating functional components such as the track device 400 and the laser head 100 of the laser processing device 1000, so as to provide isolation and protection for each functional component. The casing 200 is also provided with a pick-and-place opening 200a, and the cover plate 300 can open the pick-and-place opening 200a to place a workpiece into the accommodating space of the casing 200, or take out the processed workpiece from the casing 200. The cover plate can also close the pick-and-place opening 200a, thereby realizing the isolation of the laser head 100, so as to avoid the laser emitted by the laser head 100 from leaking to the external environment and ensure the safety of the laser processing device 1000. The casing 200 can be cuboid, and may also be cubic. The present disclosure does not limit the shape of the casing 200.

The cover plate 300 can be connected to the casing 200. For example, in some implementations, as shown in FIG. 1, the cover plate 300 can be rotatably connected to the casing 200, so as to open and close the pick-and-place opening 200a of the casing 200 by flipping the cover plate relative to the casing 200. In some implementations, the cover plate and the casing 200 may also not be connected, and the cover plate 300 can be directly placed on the casing 200 to cover the pick-and-place opening 200a, or can be directly separated from the casing 200 to open the pick-and-place opening 200a. The specific implementation can be set according to actual needs and is not limited herein.

In some implementations, a track device 400 is provided inside the casing 200, and the track device 400 can be installed and fitted with the inner wall of the casing 200, or a frame can be provided inside the casing 200 to install and fix the track device 400 through the frame. The laser head 100 is movably positioned on the track device 400, so that the laser head 100 can move relative to the workpiece placed in the casing 200 to perform laser processing on different positions of the workpiece. Specifically, the track device 400 can drive the laser head 100 to move through a linear drive mechanism, and the linear drive assembly can, but is not limited to, be implemented as a synchronous belt drive mechanism. The track device 400 can drive the laser head 100 to slide in the horizontal direction, or drive the laser head 100 to slide in the vertical direction, which is not limited herein.

In some implementations, a position sensor can be provided at the laser head 100 to realize position calibration during the processing of the laser head 100, so as to ensure the processing accuracy of the laser processing device.

Please refer to FIGS. 2 and 3. In some implementations of the present disclosure, the casing 200 includes a chassis 210, a carrying assembly 220, and a shell 230. The chassis 210 is an integrated structure and has an accommodating space, and the track device 400 is positioned on the chassis 210. The carrying assembly 220 is positioned on the chassis 210 and located at the accommodating space. The shell 230 is positioned on the chassis 210 and covers the track device 400 and the laser head 100, and the shell 230 is provided with the pick-and-place opening 200a.

Since the casing 200 is assembled from the chassis 210, the carrying assembly 220, and the shell 230, the casing 200 can be split into simple components for separate processing, which is conducive to improving the convenience of processing and forming the casing 200. Specifically, the chassis 210 can be integrally formed to ensure the structural strength of the casing 200. The chassis 210 has an accommodating space, and at least a part of the carrying assembly 220 is arranged in the accommodating space for supporting the workpiece placed in the casing 200, so that the laser head 100 can process the workpiece arranged on the carrying assembly 220.

The carrying assembly 220 can be completely accommodated in the accommodating space of the chassis 210, or a part of the carrying assembly 220 can be arranged in the accommodating space and a part exposed outside the accommodating space, which is not limited herein. The chassis 210 can be detachably connected to the carrying assembly 220 to facilitate the replacement of different carrying assemblies 220. The carrying assembly 220 can be at least one of a tray, a cutting board, and a honeycomb board, which is not limited herein.

Specifically, please refer to FIGS. 2 and 3. In some implementations of the present disclosure, the track device 400 includes a first track assembly 401 and a second track assembly 402. The first track assembly 401 is mounted on the chassis 210 and is positioned along a first direction on opposite sides of the accommodating space. The second track assembly 402 is movably positioned along a second direction on the first track assembly 401, and the laser head 100 is positioned on the second track assembly 402. In this way, the track device 400 can drive the laser head 100 to move inside the casing 200, so that the laser head 100 can move to the carrying assembly 220 to process different positions of the workpiece.

In the implementation of the present disclosure, the track device 400 further includes a front support frame 403. The front support frame 403 extends along the first direction and is connected to the two first track assemblies 401. The track device 400 further includes a lighting device 404. The lighting device 404 is positioned at an end of the front support frame 403 along the first direction and above the first track assembly 401, and is configured to provide illumination for the workpiece.

The front support frame 403 is positioned on the front side of the accommodating space, the first track assembly 401 is positioned on the left and right sides of the accommodating space, and the front support frame 403 is connected to the two first track assemblies 401 respectively. The lighting device 404 is positioned at the end of the front support frame 403, that is, the lighting device 404 is positioned on the left or right side of the accommodating space; or the lighting device 404 can be positioned on both the left and right sides of the accommodating space and correspondingly above the first track assembly 401. By positioning the lighting device 404 above the first track assembly 401, it is possible to avoid the first track assembly 401 blocking the light emitted by the lighting device 404.

Specifically, the irradiation direction of the lighting device 404 is set to be inclined downward along the length direction of the chassis 210, and the light emitted by the lighting device 404 positioned on the left and right sides of the accommodating space is directed towards the carrying assembly 220 and converges, so as to reduce the shadow area on the surface of the workpiece on the carrying assembly 220, thereby improving the uniformity of the light irradiated on the workpiece. It can be understood that, since the user usually stands on the front side of the track device 400 during operation, by positioning the lighting device 404 on the left and/or right side of the accommodating space, it is possible to avoid the light emitted by the lighting device 404 from directly shining into the user's eyes, thereby improving the safety of the laser processing device 1000.

In some implementations, the lighting device 404 includes a bracket 404a, a light strip 404b, and a light guide element 404c. The bracket 404a is arranged on the shell 230 and has an upwardly inclined mounting surface, the light strip 404b is arranged on the mounting surface, and the light guide element 404c is arranged on a side of the light strip 404b facing the carrying assembly 220, for guiding the light emitted by the light strip 404b towards the carrying assembly 220.

It can be understood that the light strip 404b can include an LED light strip 404b, and can also include an RGB light strip 404b, which is not limited herein. The bracket 404a is detachably mounted on the shell 230, and the bracket 404a is provided with a mounting surface, which is inclined upward, so that the lower surface of the light strip 404b mounted on the mounting surface is inclined downward, and the lower surface of the light strip 404b faces the carrying assembly 220, so that the light emitted by the light strip 404b is directed towards the carrying assembly 220. In addition, the light strip 404b is also provided with a light guide element 404c, and the light strip 404b includes a plurality of lamp beads. The light guide element 404c is used to convert the light sources emitted by the plurality of lamp beads into a surface light source and guide it towards the carrying assembly 220. The surface light source irradiates the surface of the workpiece on the carrying assembly 220, making the light more uniform and not dazzling, and the lighting effect is better. In addition, the light guide element 404c is made of a transparent material, which can improve the light guide effect.

In one implementation, the laser processing device 1000 can also be provided with a controller and a Hall sensor 404d, and a magnetic element is provided on the cover plate 300 corresponding to the Hall sensor 404d. The Hall sensor 404d can be arranged on the lighting device 404 and cooperate with the magnetic element to sense the opening or closing of the cover plate 300, and the controller is used to control the brightness of the lighting device 404 according to the sensing signal of the Hall sensor 404d. When the cover plate 300 is in the open state, the brightness of the lighting device 404 is dim. When the cover plate 300 is in the closed state, the brightness of the lighting device 404 is bright, so as to reduce the stimulation of the lighting device 404 to the user's eyes, thereby improving the reliability of the laser processing device 1000.

Specifically, when the Hall sensor 404d senses the magnetic element on the cover plate 300, it indicates that the cover plate 300 is closed on the shell 230, and the Hall sensor 404d sends a first sensing signal to the controller. At this time, after receiving the first sensing signal, the controller can control the brightness of the lighting device 404 to become brighter according to the first sensing signal because the cover plate 300 is closed on the shell 230. When the Hall sensor 404d does not sense the magnetic element on the cover plate 300, it indicates that the cover plate 300 is in the open state, and the Hall sensor 404d sends a second sensing signal to the controller. At this time, after receiving the second sensing signal, the controller can control the brightness of the lighting device 404 to become dimmer according to the second sensing signal because the cover plate 300 is in an open state.

In addition, the track device 400 can further include a rear support frame. The rear support frame extends along the first direction and is connected to the two first track assemblies 401, and the rear support frame is positioned on the rear side of the first track assembly 401. The front support frame 403 and the rear support frame can be arranged opposite each other along the second direction.

Please refer to FIG. 3. In some implementations of the present disclosure, a mounting portion 211 protrudes from a side of the chassis 210 facing the laser head 100, and the laser processing device 1000 further includes a flame sensor 212 for sensing a flame. The flame sensor 212 is positioned on the mounting portion 211 and above the carrying assembly 220.

The number of flame sensors 212 can be one, two, or more. By providing a plurality of flame sensors 212, the plurality of flame sensors 212 can cooperatively sense flames, which is conducive to increasing the sensing range of the flame sensors 212. In addition, when one of the plurality of flame sensors 212 is damaged, the remaining flame sensors 212 can still sense whether there is a flame in the processing space on the carrying assembly 220, so as to ensure the reliability of the laser processing device 1000.

When there are a plurality of flame sensors 212, the plurality of flame sensors 212 can all be arranged on the mounting portion 211. For example, in some implementations, the plurality of flame sensors 212 are sequentially spaced along the length direction of the mounting portion 211. The plurality of flame sensors 212 can also be partially arranged on the mounting portion 211 and partially arranged on other components of the laser processing device 1000. The present disclosure does not limit the number and installation position of the flame sensors 212.

For example, in some implementations, the front support frame 403 and the mounting portion 211 are positioned on opposite sides of the accommodating space of the chassis 210, and both the front support frame 403 and the mounting portion 211 are provided with flame sensors 212. The flame sensors 212 on the front support frame 403 and the flame sensors 212 on the mounting portion 211 can be arranged in a staggered manner along the direction from the front support frame 403 to the mounting portion 211. Specifically, the flame sensor 212 on the front support frame 403 can be arranged in the middle of the front support frame 403, and the flame sensor 212 on the front support frame 403 is positioned between the two first flame sensors 212 on the first mounting portion 211 along the length direction of the first mounting portion 211. In addition, the flame sensor can also be arranged on the chassis 210, the track device 400, or near the laser head 100, to detect the flame situation during processing and provide early warning of fire risk.

The above are only exemplary implementations of the present disclosure and do not limit the scope of the present disclosure. Any equivalent structural transformation made under the technical concept of the present disclosure using the content of the present disclosure and the drawings, or directly/indirectly applied to other related technical fields, are all included within the scope of protection of the present disclosure.

What is claimed is:

1. A laser head, comprising:
a housing, wherein the housing forms an accommodating cavity, and one end of the housing is provided with a light outlet in communication with the accommodating cavity;
a laser assembly, wherein the laser assembly is arranged within the accommodating cavity, and is configured to move in a light emission direction towards the light outlet; and
a guide rail assembly, wherein the guide rail assembly is arranged within the accommodating cavity and is configured to slide with the laser assembly,
wherein the guide rail assembly comprises:
a guiding portion, wherein the guiding portion is positioned on one side of the laser assembly, the guiding portion has a slideway facing the laser assembly, and the slideway extends in the light emission direction of the laser assembly; and
a rolling portion, wherein the rolling portion is positioned within the slideway, at least a part of the rolling portion is configured to roll, and at least a part of the laser assembly is constrained within the slideway and engages with the rolling portion to allow the laser assembly to slide relative to the guiding portion.

2. The laser head according to claim 1, wherein the rolling portion comprises a rolling element, and an outer peripheral surface of the rolling element abuts the laser assembly to engage with the laser assembly in a rolling manner; and
wherein a plurality of rolling elements are provided, and the plurality of rolling elements are arranged within the slideway and are sequentially arranged along a length direction of the slideway.

3. The laser head according to claim 2, wherein the rolling portion further comprises a mounting element, the mounting element is positioned within the slideway and on one side of the laser assembly, and extends along the length direction of the slideway; and
wherein the plurality of rolling elements are sequentially arranged along a length direction of the mounting element, and are respectively rotatably mounted on the mounting element, with at least a part of the rolling elements protruding from a side surface of the mounting element facing the laser assembly to abut the laser assembly.

4. The laser head according to claim 3, wherein the rolling element has a central axis and is rotatable around the central axis, and the central axis is perpendicular to the light emission direction of the laser assembly; or
wherein the laser assembly is provided with a first groove on a side facing the mounting element, the first groove is positioned opposite the mounting element and extends along the length direction of the mounting element, and at least a part of the rolling element is limited within the first groove; or
wherein an inner wall of the slideway is provided with a second groove, the second groove is positioned opposite the mounting element and extends along the length direction of the mounting element, and at least a part of the rolling element protrudes from a side surface of the mounting element facing the second groove and is limited within the second groove.

5. The laser head according to claim 1, wherein the guiding portion comprises two side edge structures, and the two side edge structures are arranged at an interval to enclose and form the slideway, with at least a part of the laser assembly being constrained between the two side edge structures; and
wherein two rolling portions are provided, and each side edge structure is provided with one rolling portion on a side facing the other side edge structure.

6. The laser head according to claim 5, wherein the guiding portion further comprises a mounting structure, the mounting structure is positioned on a side chamber wall of the accommodating cavity, and the two side edge structures are arranged at an interval on a side of the mounting structure away from the chamber wall to enclose and form the slideway with the mounting structure.

7. The laser head according to claim 1, further comprising a mainboard assembly, wherein the mainboard assembly is positioned within the accommodating cavity and is arranged at an interval on a side of the laser assembly away from the guide rail assembly, and extends along the light emission direction of the laser assembly.

8. The laser head according to claim 7, wherein a plug structure is provided on a side of the mainboard assembly away from the laser assembly; and
wherein an outer side wall of the housing is provided with a socket in communication with the accommodating cavity, the socket is positioned opposite the plug structure, and the plug structure passes through the socket.

9. The laser head according to claim 7, further comprising a drive assembly, wherein the drive assembly is positioned within the accommodating cavity and located between the mainboard assembly and the guide rail assembly, and is adjacent to the laser assembly; and
wherein the drive assembly is in transmission connection with the laser assembly to drive the laser assembly to reciprocate relative to the guide rail assembly.

10. The laser head according to claim 1, wherein an end of the housing away from the light outlet is provided with a wind-passing opening in communication with the accommodating cavity, and at least a part of the laser assembly is spaced from a chamber wall of the accommodating cavity to enclose and form a heat dissipation air duct in communication with the wind-passing opening and the light outlet; and
wherein the laser head further comprises a fan assembly, and the fan assembly is positioned within the heat dissipation air duct.

11. The laser head according to claim 10, further comprising a heat dissipation assembly, wherein the heat dissipation assembly is positioned within the heat dissipation air duct and located around the laser assembly, and is connected to the laser assembly; and
wherein the wind-passing opening is positioned on a side wall of the housing, and the fan assembly is positioned on a side of the laser assembly away from the light outlet and adjacent to the wind-passing opening, to guide airflow to enter the heat dissipation air duct from a side of the laser head, so that after flowing through the laser assembly and the heat dissipation assembly, the airflow blows towards the front of the light outlet.

12. The laser head according to claim 11, wherein two heat dissipation assemblies are provided, and the two heat dissipation assemblies are positioned on opposite sides of the laser assembly; or
wherein an outer surface of the laser assembly is provided with a slot, and the heat dissipation assembly is inserted into the slot; or
wherein the heat dissipation assembly comprises a plurality of heat dissipation elements, the heat dissipation elements are tubular, and the plurality of heat dissipation elements are sequentially arranged along the light emission direction of the laser assembly.

13. A laser processing device, comprising:
the laser head according to claim 1;
a casing, wherein the casing is provided with a pick-and-place opening in communication with an inside of the casing;
a cover plate, wherein the cover plate is configured for opening and closing the pick-and-place opening; and
a track device, wherein the track device is positioned within the casing, and the laser head is movably positioned on the track device.

14. The laser processing device according to claim 13, wherein the casing comprises:
a chassis, wherein the chassis is an integrated structure and is provided with an accommodating space, and the track device is positioned on the chassis;
a carrying assembly, wherein the carrying assembly is positioned on the chassis and located at the accommodating space, and the laser head is configured to process a workpiece positioned on the carrying assembly; and
a shell, wherein the shell is positioned on the chassis and covers the track device and the laser head, and the shell is provided with the pick-and-place opening.

15. The laser processing device according to claim 14, wherein the track device comprises:
a first track assembly, wherein the first track assembly is mounted on the chassis and is positioned along a first direction on opposite sides of the accommodating space; and
a second track assembly, wherein the second track assembly is movably positioned along a second direction on the first track assembly, and the laser head is positioned on the second track assembly.

16. The laser processing device according to claim 15, wherein the track device further comprises a front support frame, the front support frame extends along the first direction and is connected to the two first track assemblies; and
wherein the track device further comprises a lighting device, the lighting device is positioned at an end of the front support frame along the first direction and above the first track assembly, and is configured to provide illumination for the workpiece.

17. The laser processing device according to claim 14, wherein a mounting portion protrudes from a side of the chassis facing the laser head, and the laser processing device further comprises a flame sensor for sensing a flame, and the flame sensor is positioned on the mounting portion and above the carrying assembly.

18. The laser processing device according to claim 13, wherein the rolling portion comprises a rolling element, and an outer peripheral surface of the rolling element abuts the laser assembly to engage with the laser assembly in a rolling manner; and
wherein a plurality of rolling elements are provided, and the plurality of rolling elements are arranged within the slideway and are sequentially arranged along a length direction of the slideway.

19. The laser processing device according to claim 18, wherein the rolling portion further comprises a mounting element, the mounting element is positioned within the slideway and on one side of the laser assembly, and extends along the length direction of the slideway; and
wherein the plurality of rolling elements are sequentially arranged along a length direction of the mounting element, and are respectively rotatably mounted on the mounting element, with at least a part of the rolling elements protruding from a side surface of the mounting element facing the laser assembly to abut the laser assembly.

20. The laser processing device according to claim 19, wherein the rolling element has a central axis and is rotatable around the central axis, and the central axis is perpendicular to the light emission direction of the laser assembly; or
wherein the laser assembly is provided with a first groove on a side facing the mounting element, the first groove is positioned opposite the mounting element and extends along the length direction of the mounting element, and at least a part of the rolling element is limited within the first groove; or
wherein an inner wall of the slideway is provided with a second groove, the second groove is positioned opposite the mounting element and extends along the length direction of the mounting element, and at least a part of the rolling element protrudes from a side surface of the mounting element facing the second groove and is limited within the second groove.
